(19) United States
(12) Patent Application Publication
(10) Pub. No.: US 2009/0109156 A1
(43) Pub. Date: Apr. 30, 2009

(54) ACTIVE DEVICE ARRAY SUBSTRATE, PIXEL STRUCTURE THEREOF AND DRIVING METHOD THEREOF

(75) Inventors: Chih-Jen Hu, Hsinchu City (TW); Meng-Chang Tsai, Chiayi City (TW); Ching-Sheng Cheng, Kaohsiung County (TW); Tsung-Chin Cheng, Kaohsiung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AU Optronics Corporation, Hsinchu (TW)

(21) Appl. No.: 12/242,864

(22) Filed: Sep. 30, 2008

(30) Foreign Application Priority Data
Oct. 24, 2007 (TW) 96139850

(51) Int. Cl. G09G 3/36; G02F 1/136

(52) U.S. Cl. 345/89; 349/46

(57) ABSTRACT

A pixel structure including a first transparent electrode, a second transparent electrode, a reflective electrode, a first active device and a second active device is provided. The reflective electrode connects the second transparent electrode, while the first transparent electrode is electrically insulated from the second transparent electrode and the reflective electrode. The first active device electrically connects the first transparent electrode to apply a first driving voltage to the first transparent electrode. The second active device electrically connects the second transparent electrode and the reflective electrode to apply a second driving voltage to the second transparent electrode and the reflective electrode. The first driving voltage differs from the second driving voltage. An active device array substrate having the abovementioned pixel structure and a driving method of the active device array substrate are also provided and applied to a transflective liquid crystal display for improving the display quality thereof.

### CROSS-REFERENCE TO RELATED APPLICATION

This application claims the priority benefit of Taiwan application serial no. 96139850, filed Oct. 24, 2007. The entirety of the above-mentioned patent application is hereby incorporated by reference herein and made a part of this specification.

### BACKGROUND OF THE INVENTION

1. Field of the Invention

The present invention relates to a pixel structure, an active device array substrate having the pixel structure, and a driving method of the active device array substrate. More particularly, the present invention relates to a transflective pixel structure, an active device array substrate having the transflective pixel structure, and a driving method of the active device array substrate.

2. Description of Related Art

Liquid crystal displays (LCDs) are non-self-illuminating displays, and thus external light sources having sufficient luminance are required by LCD panels. According to types of light sources, the LCDs are classified into reflective LCDs, transmissive LCDs, and transflective LCDs. The transflective LCD panel utilizing both a back-light source and the external light source simultaneously is adapted to be applied to portable products, such as a mobile phone, a personal digital assistant (PDA), an e-Book, and so on. Hence, the transflective LCD panel has been prominent little by little.

Despite a variety of intensity supplied by different external light sources, the transflective LCD panel enables a user to view images. However, gray-level curves of the images displayed in a transmissive display region and a reflective display region of the transflective LCD panel are not consistent. FIG. 1 is a curve depicting characteristics of a gray-level value of an image with respect to a transmittance in a transmissive display region and a reflective display region of a conventional transflective LCD having a single cell gap. Said curve is referred to as a Gamma curve. Referring to FIG. 1, a curve 110 represents the Gamma curve in the transmissive display region, while a curve 120 denotes the Gamma curve in the reflective display region. Variations in the trend of the curve 110 and that of the curve 120 are of a significant difference. As the same image is displayed in the transmissive display region and in the reflective display region, the gray-level values of the displayed image in said regions are inconsistent, thus deteriorating a display quality of the LCD. Accordingly, most of the transflective LCDs are designed for resolving said issue. For example, a dual-cell-gap design or a coupling capacitance has been proposed in this regard. However, both the formation of the dual cell gap and the formation of the coupling capacitance complicate a manufacturing process of the transflective LCD. Further, an aperture ratio of the transflective LCD is adversely affected.

Aside from the above, as the LCD performs a display function, the gray-level value of the image varies when the image is in side vision or in front vision due to optical properties of liquid crystal molecules of the LCD, resulting in color washout and accordingly deteriorating the display quality of the LCD. In particular, with the continuous advancement of larger-sized LCDs having wide viewing angles, the drawback of color washout in the LCDs has been more and more intolerable for the users. Accordingly, how to reduce color washout seems to have become one of the main research topics recently.

### SUMMARY OF THE INVENTION

The present invention is directed to a pixel structure having a single-cell-gap design for improving a display quality of a transflective LCD.

The present invention is further directed to an active device array substrate which can be applied to an LCD, so as to reduce color washout when the LCD performs a display function.

The present invention is further directed to a driving method of an active device array substrate applicable to a transflective LCD, so as to enhance display performance thereof.

The present invention provides a pixel structure including a first transparent electrode, a second transparent electrode, a reflective electrode, a first active device and a second active device. The reflective electrode connects the second transparent electrode, while the first transparent electrode is electrically insulated from the second transparent electrode and the reflective electrode. The first active device electrically connects the first transparent electrode, so as to apply a first driving voltage to the first transparent electrode. By contrast, the second active device electrically connects the second transparent electrode and the reflective electrode to apply a second driving voltage to the second transparent electrode and the reflective electrode. Here, the first driving voltage differs from the second driving voltage.

The present invention further provides an active device array substrate including a substrate, a plurality of first data lines, a plurality of second data lines, a plurality of scan lines, and a plurality of pixel structures. The second data lines extend along the same direction as that of the first data lines, while the scan lines cross the first data lines and the second data lines. The pixel structures are arranged in array on the substrate. Each of the pixel structures includes a first transparent electrode, a second transparent electrode, a reflective electrode, a first active device, and a second active device. The reflective electrode connects the second transparent electrode, while the first transparent electrode is electrically insulated from the second transparent electrode and the reflective electrode. The first active device electrically connects the first transparent electrode and is driven by the corresponding scan line and the corresponding first data line, so as to apply a first driving voltage to the first transparent electrode. On the other hand, the second active device electrically connects the second transparent electrode and the reflective electrode, and the second active device is driven by the corresponding scan line and the corresponding second data line, so as to apply a second driving voltage to the second transparent electrode and the reflective electrode. Note that the first driving voltage differs from the second driving voltage.

According to an embodiment of the present invention, the first driving voltage in each of the pixel structures is less than the second driving voltage therein, for example. In an alternative, according to another embodiment of the present invention, the first driving voltage in each of the pixel structures is greater than the second driving voltage therein.

According to an embodiment of the present invention, at least one of the first active device and the second active device in each of the pixel structures is disposed below the reflective electrode. Besides, the first active device or the second active device is a thin film transistor (TFT), for example.

According to an embodiment of the present invention, a material of the first transparent electrode or a material of the second transparent electrode includes indium tin oxide (ITO) or indium zinc oxide (IZO), while a material of the reflective electrode can be metals.

According to an embodiment of the present invention, the active device array substrate further includes a photo sensor disposed on the substrate.

The present invention further provides a driving method of an active device array substrate. Here, the active device array substrate includes a substrate, a plurality of first data lines, a plurality of second data lines, a plurality of scan lines, and a plurality of pixel structures. The second data lines extend along the same direction as that of the first data lines, while the scan lines cross the first data lines and the second data lines. The pixel structures are arranged in array on the substrate. Each of the pixel structures includes a first transparent electrode, a second transparent electrode, a reflective electrode, a first active device, and a second active device. The reflective electrode connects the second transparent electrode, while the first transparent electrode is electrically insulated from the second transparent electrode and the reflective electrode. The first active device electrically connects the first transparent electrode and is driven by the corresponding scan line and the corresponding first data line. On the other hand, the second active device electrically connects the second transparent electrode and the reflective electrode, and the second active device is driven by the corresponding scan line and the corresponding second data line. Here, the driving method includes applying a first driving voltage through each of the first data lines to the corresponding first transparent electrode. A second driving voltage is also applied to the corresponding second transparent electrode and the corresponding reflective electrode through each of the second data lines. The first driving voltage in each of the pixel structures differs from the second driving voltage therein.

According to another embodiment of the present invention, the first driving voltage in each of the pixel structures is less than the second driving voltage therein. Alternatively, the first driving voltage in each of the pixel structures is greater than the second driving voltage therein.

According to another embodiment of the present invention, the driving method of the active device array substrate further includes changing the first driving voltage and the second driving voltage in each of the pixel structures based on intensity of an external light source. The intensity of the external light source is, for example, detected by a photo sensor disposed at peripheries of the active device array substrate.

Through the above-mentioned design, different driving voltages can be applied to the pixel electrodes in two different regions of the same pixel structure, so as to resolve issues with respect to color washout and inconsistency of Gamma curves in a transmissive region and in a reflective region of a display. Further, the pixel structure is driven in different ways based on the corresponding display mode of the display and intensity of the external light source, such that the aforesaid issues are resolved, and a desired display quality is further achieved.

In order to the make the aforementioned and other objects, features and advantages of the present invention comprehensible, several embodiments accompanied with figures are described in detail below.

### BRIEF DESCRIPTION OF THE DRAWINGS

FIG. 1 is a Gamma curve depicting characteristics of a gray-level value of an image with respect to a transmittance in a transmissive display region and a reflective display region of a conventional transflective LCD having a single cell gap.

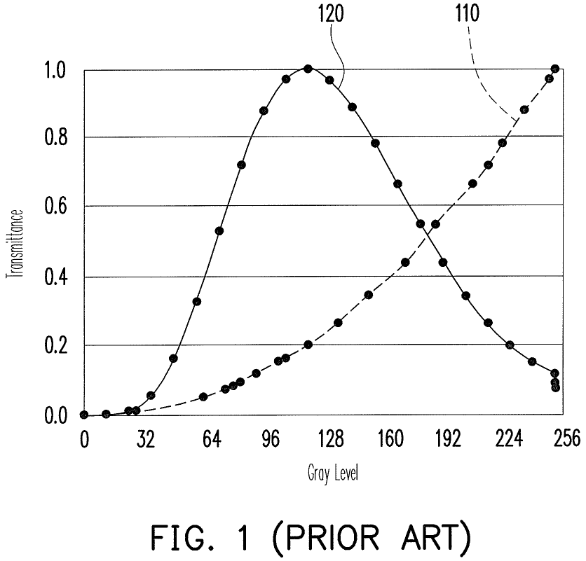

FIGS. 2A and 2B are schematic top views illustrating two pixel structures according to an embodiment of the present invention.

FIG. 3 is a schematic side view illustrating the pixel structure 200B in FIG. 2B.

FIG. 4 is a schematic partial view depicting an active device array substrate according to an embodiment of the present invention.

FIG. 5 is a Gamma curve illustrating characteristics of a gray-level value of an image with respect to a transmittance when a pixel structure of an active device array substrate is in a first driving mode according to the present invention.

FIG. 6 is another Gamma curve illustrating characteristics of the gray-level value of the image with respect to the transmittance when the pixel structure of the active device array substrate is in a second driving mode according to the present invention.

### DESCRIPTION OF EMBODIMENTS

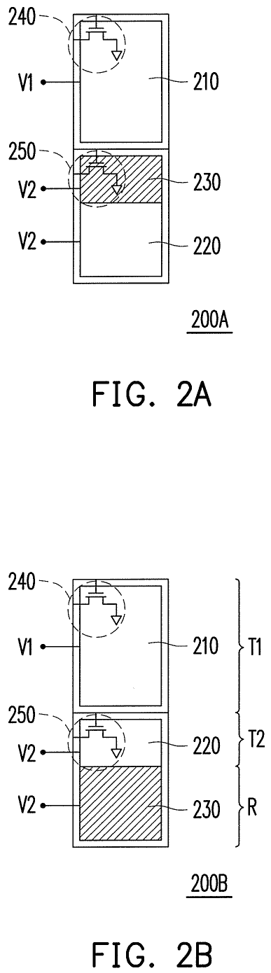

FIG. 2A is a schematic top view of a pixel structure according to an embodiment of the present invention. Referring to FIG. 2A, a pixel structure 200A includes a first transparent electrode 210, a second transparent electrode 220, a reflective electrode 230, a first active device 240, and a second active device 250. The reflective electrode 230 connects the second transparent electrode 220, while the first transparent electrode 210 is electrically insulated from the second transparent electrode 220 and the reflective electrode 230. The first active device 240 electrically connects the first transparent electrode 210 to apply a first driving voltage V1 to the first transparent electrode 210. Besides, the second active device 250 electrically connects the second transparent electrode 220 and the reflective electrode 230 to apply a second driving voltage V2 to the second transparent electrode 220 and the reflective electrode 230. The first driving voltage V1 differs from the second driving voltage V2.

Specifically, the first active device 240 or the second active device 250 is, for example, a TFT or other active devices applied to an active device array substrate in the pertinent art. In addition, a material of the first transparent electrode 210 or a material of the second transparent electrode 220 includes a transparent conductive material such as ITO or IZO. By contrast, a material of the reflective electrode 230 can be a metal or other conductive materials characterized by reflectivity.

It should be noted that the second active device 250 is disposed below the reflective electrode 230 in the pixel structure 200A depicted in FIG. 2A. Said design does not pose any impact on the aperture ratio of the pixel structure 200A due to the disposition of the second active device 250. Certainly, the location of the first active device 240 and that of the second active device 250 are not limited in the present invention. According to other embodiments, at least one of the first active device 240 and the second active device 250 is disposed below the reflective electrode 230 based on actual requirements. In an alternative, the first active device 240 and the second active device 250 can be disposed outside the reflective electrode 230.

FIG. 2B illustrates the pixel structure according to another embodiment of the present invention. Similar reference numbers in FIGS. 2A and 2B represent similar elements. Accordingly, relevant descriptions can be found in the previous embodiment, and no further explanation in relation to the similar elements will be provided herein. The difference between the pixel structure 200A in FIG. 2A and a pixel structure 200B in FIG. 2B lies in that the second active device 250 of the pixel structure 200B is disposed outside the reflective electrode 230.

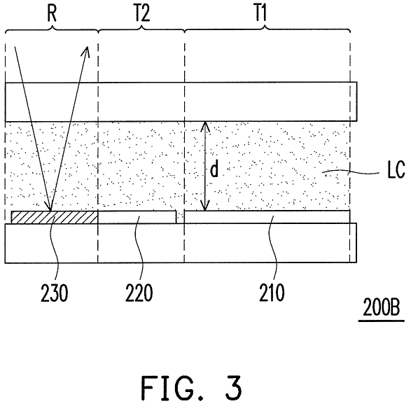

FIG. 3 is a schematic side view illustrating the pixel structure in FIG. 2B provided hereinbefore. Referring to FIGS. 2B and 3, the pixel structure 200B is divided into a first transmissive display region T1, a second transmissive display region T2, and a reflective display region R for illustrative purposes. The first transmissive display region T1 where the first transparent electrode 210 is disposed is controlled by the first active device 240. The second transmissive display region T2 where the second transparent electrode 220 is disposed is controlled by the second active device 250. In addition, the reflective display region R where the reflective electrode 230 is disposed is also controlled by the second active device 250. The pixel structure 200B having a single cell gap d is capable of individually adjusting the second driving voltage V2 on the reflective electrode 230 because the first transparent electrode 210 is separated from the second transparent electrode 220 and the reflective electrode 230. Thereby, the gray-level value of the reflective display region R of the pixel structure 200B can be adjusted, minimizing the difference between the gray-level value of the reflective display region R and that of the first transmissive display region T1.

On the other hand, referring to FIGS. 2B and 3, since the first driving voltage V1 and the second driving voltage V2 are respectively applied to the first transparent electrode 210 and the second transparent electrode 220, the gray-level values of the first transmissive display region T1 and the second transmissive display region T2 are distinctive in line with the different first driving voltage V1 and the second driving voltage V2, so as to compensate the color washout effect.

In general, the gray-level values of the transmissive region and the reflective region can be consistent through dividing the pixel structure into two separate portions and respectively driving the two active devices according to the present invention. Moreover, color washout can be reduced as well. The aforesaid driving method is described through applying said method to the pixel structure 200B depicted in FIG. 2B. Nevertheless, the driving method can also be applied to other pixel structures (e.g. the pixel structure 200A illustrated in FIG. 2A) disclosed by the present invention. As such, the display quality of the LCD display can be improved. Note that the first driving voltage V1 is either less than or greater than the second driving voltage, which is not limited in the present invention.

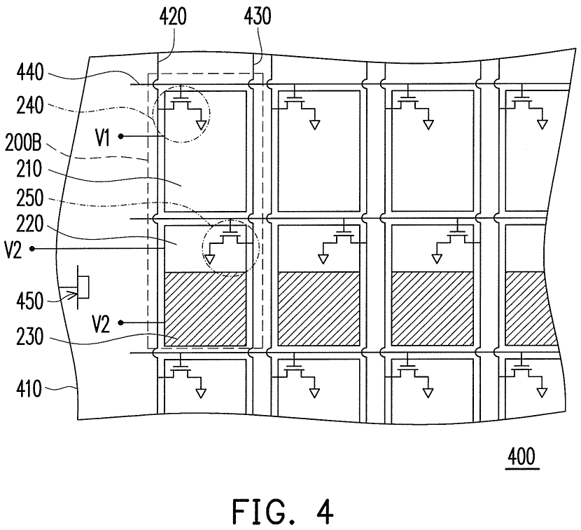

In view of the pixel structures described hereinbefore, an active device array substrate applying said pixel structures is further proposed in the present invention. FIG. 4 is a schematic partial view depicting an active device array substrate employing the pixel structure 200B provided in the previous embodiment. As illustrated in FIG. 4, an active device array substrate 400 includes a substrate 410, a plurality of first data lines 420, a plurality of second data lines 430, a plurality of scan lines 440, and a plurality of the pixel structures 200B. It is of certainty that the pixel structure in this present embodiment need not be the pixel structure 200B. In other words, the pixel structure 200A or any other pixel structures described in the previous embodiments can be adopted in the active device array substrate 400.

The second data lines 430 extend along the same direction as that of the first data lines 420, while the scan lines 440 cross the first data lines 420 and the second data lines 430. The pixel structures 200B are arranged in array on the substrate 410 and are driven through the scan lines 440, the first data lines 420, and the second data lines 430, respectively. In detail, the first active device 240 in each of the pixel structures 200B is driven by the corresponding scan line 440 and the corresponding first data line 420, for example. Additionally, the second active device 250 in each of the pixel structures 200B is driven by the corresponding scan line 440 and the corresponding second data line 430, for example. As such, the first driving voltage V1 can be inputted into the first transparent electrode 210 through the first active device 240, while the second driving voltage V2 can be inputted into the second transparent electrode 220 and the reflective electrode 230 through the second active device 250.

It should be noticed that the pixel structure is driven in different ways based on actual requirements for intensity of the external light source, the display mode of the corresponding display, and so on. Thereby, specific issues regarding display performance are resolved, and a desired display quality is further achieved. For example, a photo sensor 450 can be further disposed at peripheries of the active device array substrate 400 according to the embodiment illustrated in FIG. 4. As an LCD (not shown) formed by filling liquid crystal molecules between the active device array substrate 400 and an opposite substrate (not shown) assembled thereto, the external light source can be detected by the photo sensor 450, such that the driving mode of the LCD (not shown) can be adjusted thereby. Specifically, the photo sensor 450 is, for example, fabricated together with the active devices 240 and 250 on the active device array substrate 400 through integrating a low temperature polysilicon (LTPS) manufacturing process. In an alternative, after the fabrication of the active device array substrate 400 is completed, the photo sensor 450 can be disposed next to the active device array substrate 400 during a panel-assembling process.

In order to ensure a thorough disclosure of the present invention, a driving method of the active device array substrate according to the present invention is provided as follows. In the driving method, the first driving voltage is applied to the corresponding first transparent electrode through each of the first data lines, while the second driving voltage is applied to the corresponding second transparent electrode and the corresponding reflective electrode through each of the second data lines. Here, the first driving voltage in each of the pixel structures differs from the second driving voltage therein. In practice, the first driving voltage is either less than or greater than the second driving voltage.

Moreover, in the driving method of the present invention, the first driving voltage and the second driving voltage in each of the pixel structures can be changed based on the intensity of the external light source. According to the present embodiment, the intensity of the external light source is detected by the photo sensor disposed at the peripheries of the active device array substrate, so as to change the first driving voltage and the second driving voltage in each of the pixel structures based on variations in the intensity of the external light source. That is to say, the active device array substrate of the present invention can be driven in different modes upon various conditions of the surroundings.

In particular, as the external light source is of great intensity or the back-light source of the LCD is not available, the reflective display region is able to utilize the external light source for providing a part of or the whole display light source. Namely, the reflective display region is conducive to an improvement of the display effect to some degree. However, in order to maximize the display quality of each of the pixel structures, the Gamma curve in the reflective display region should be adjusted and corrected as flawless as possible. Here, a first specific relationship between the first driving voltage and the second driving voltage is drawn. The first specific relationship is called a first driving mode according to the present embodiment. Further, in order to achieve the satisfactory wide-viewing-angle display quality of each of the pixel structures, the color washout effect occurring when an image is in side vision should be prevented. Here, a second specific relationship between the first driving voltage and the second driving voltage is drawn. The second specific relationship is called a second driving mode according to the present embodiment. As a matter of fact, the active device array substrate can be driven in either the first driving mode or the second driving mode by means of the photo sensor detecting the intensity of the external light source. The first driving mode and the second driving mode can also be switched manually based on other requirements according to other embodiments.

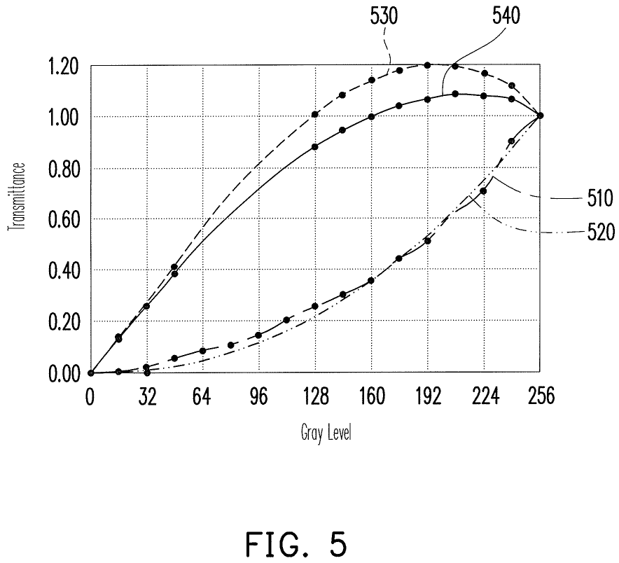

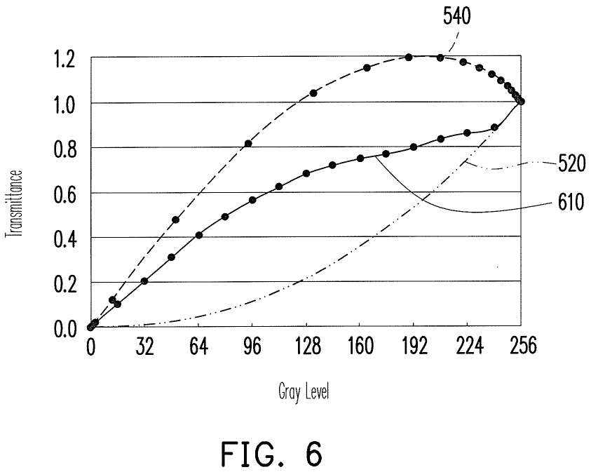

FIGS. 5 and 6 are Gamma curves illustrating characteristics of the gray-level value of an image with respect to a transmittance when the pixel structure of the active device array substrate of the present invention is in the first driving mode and in the second driving mode, respectively. Referring to FIG. 5, a curve 510 represents the gray-level value of an image in front vision with respect to the transmittance when the pixel structure of the present invention is in the first driving mode. By contrast, a curve 520 is referred to as an ideal Gamma curve (γ=2.2). The trend of the curve 510 and that of the curve 520 are not of a great difference, and thus the display quality of the reflective display region in the first driving mode is quite desirable. In other words, the display effect of the reflective display region can be well compensated when the pixel structure is in the first driving mode.

On the other hand, a curve 530 depicted in FIG. 5 represents a gray-level curve indicating an image is in a 60-degree vision when the image is displayed in a first display region of the pixel structure of the present invention. The difference between the curve 530 and the ideal gray-level curve 520 is rather significant, thus giving rise to color washout. By contrast, a curve 540 represents a gray-level curve indicating the image is in the 60-degree vision when the image is displayed in the first display region and in a second display region of the pixel structure of the present invention. Here, the pixel structure is in the first driving mode. In comparison with the curve 530, the curve 540 and the ideal gray-level curve 520 are more alike. In light of the foregoing, the design of the pixel structure of the present invention is conducive to reducing color washout when the pixel structure is in the first driving mode. Accordingly, the pixel structure in the first driving mode not only achieves a favorable display quality of the transflective LCD, but also reduce color washout arisen from the wide viewing angle.

Besides, when the image displayed by the LCD denotes the image displayed in the transmissive region, the display effect in the reflective display region need not be adjusted, and thus the reflective display region can be set in the second driving mode rather than in the first driving mode. Referring to FIG. 6, a curve 610 represents the gray-level value of the image in the 60-degree vision when the pixel structure of the present invention is in the second driving mode. Referring to FIG. 6, it is not the curve 540 but the curve 610 which resembles the ideal gray-level curve 520 to a greater extent, and accordingly color washout can be significantly reduced.

To sum up, the pixel structure of the present invention can be equipped with the single cell gap and can be applied to the transflective LCD. According to the present invention, the pixel electrode is divided into two separate regions including a first region constituted by the first transparent electrode and a second region constituted by the second transparent electrode and the reflective electrode. By applying the driving voltages to the two separate regions through the two active devices, display states of said two regions can be adjusted respectively. For example, the gray-level values of the reflective region and the transmissive region are uniformized after the driving voltage applied to the first transparent electrode is in line with the driving voltage applied to the reflective electrode. Further, the problem of color washout can be resolved after the driving voltage applied to the first transparent electrode is in line with the driving voltage applied to the second transparent electrode.

On the other hand, the pixel structure is driven in different ways based on the intensity of the external light source and the display mode of the corresponding display, such that the aforesaid issues can be resolved, and a desired display quality can be achieved as well. Furthermore, the active device of the present invention can be disposed below the reflective electrode, so as to maintain the high aperture ratio of the pixel structure.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel structure, comprising:
a first transparent electrode;
a second transparent electrode;
a reflective electrode connecting the second transparent electrode, wherein the first transparent electrode is electrically insulated from the second transparent electrode and the reflective electrode;
a first active device electrically connecting the first transparent electrode to apply a first driving voltage to the first transparent electrode; and
a second active device electrically connecting the second transparent electrode and the reflective electrode to apply a second driving voltage to the second transparent electrode and the reflective electrode, wherein the first driving voltage differs from the second driving voltage.

2. The pixel structure of claim 1, wherein the first driving voltage is less than the second driving voltage.

3. The pixel structure of claim 1, wherein the first driving voltage is greater than the second driving voltage.

4. The pixel structure of claim 1, wherein at least one of the first active device and the second active device is disposed below the reflective electrode.

5. The pixel structure of claim 1, wherein at least one of the first active device and the second active device is a thin film transistor.

6. The pixel structure of claim 1, wherein the first transparent electrode or the second transparent electrode is comprised of indium tin oxide or indium zinc oxide.

7. The pixel structure of claim 1, wherein the reflective electrode includes a metal.

8. An active device array substrate, comprising:
a substrate;
a plurality of first data lines;
a plurality of second data lines extending along the same direction as that of the first data lines;
a plurality of scan lines crossing the first data lines and the second data lines;
a plurality of pixel structures arranged in array on the substrate, each of the pixel structures comprising:
a first transparent electrode;
a second transparent electrode;
a reflective electrode connecting the second transparent electrode, wherein the first transparent electrode is electrically insulated from the second transparent electrode and the reflective electrode;
a first active device electrically connecting the first transparent electrode and driven by the corresponding scan line and the corresponding first data line, so as to apply a first driving voltage to the first transparent electrode; and
a second active device electrically connecting the second transparent electrode and the reflective electrode and driven by the corresponding scan line and the corresponding second data line, so as to apply a second driving voltage to the second transparent electrode and the reflective electrode, wherein the first driving voltage differs from the second driving voltage.

9. The active device array substrate of claim 8, wherein the first driving voltage in each of the pixel structures is less than the second driving voltage therein.

10. The active device array substrate of claim 8, wherein the first driving voltage in each of the pixel structures is greater than the second driving voltage therein.

11. The active device array substrate of claim 8, wherein at least one of the first active device and the second active device in each of the pixel structures is disposed below the reflective electrode.

12. The active device array substrate of claim 8, further comprising a photo sensor disposed on the substrate.

13. The active device array substrate of claim 8, wherein at least one of the first active device and the second active device is a thin film transistor.

14. The active device array substrate of claim 8, wherein the first transparent electrode or a material of the second transparent electrode is comprised of indium tin oxide or indium zinc oxide.

15. The active device array substrate of claim 8, wherein the reflective electrode comprises a metal.

16. A driving method of an active device array substrate, the active device array substrate comprising:
a substrate;
a plurality of first data lines;
a plurality of second data lines extending along the same direction as that of the first data lines;
a plurality of scan lines crossing the first data lines and the second data lines;
a plurality of pixel structures arranged in array on the substrate, each of the pixel structures comprising:
a first transparent electrode;
a second transparent electrode;
a reflective electrode connecting the second transparent electrode, wherein the first transparent electrode is electrically insulated from the second transparent electrode and the reflective electrode;
a first active device electrically connecting the first transparent electrode and driven by the corresponding scan line and the corresponding first data line; and
a second active device electrically connecting the second transparent electrode and the reflective electrode and driven by the corresponding scan line and the corresponding second data line,
the driving method comprising:
applying a first driving voltage to the corresponding first transparent electrode through each of the first data lines; and
applying a second driving voltage to the corresponding second transparent electrode and the corresponding reflective electrode through each of the second data lines, wherein the first driving voltage in each of the pixel structures differs from the second driving voltage therein.

17. The driving method of claim 16, wherein the first driving voltage in each of the pixel structures is less than the second driving voltage therein.

18. The driving method of claim 16, wherein the first driving voltage in each of the pixel structures is greater than the second driving voltage therein.

19. The driving method of claim 16, further comprising changing the first driving voltage and the second driving voltage in each of the pixel structures based on intensity of an external light source.

20. The driving method of claim 19, wherein the intensity of the external light source is detected by a photo sensor disposed at peripheries of the active device array substrate.
